(19) United States
(12) Patent Application Publication
(10) Pub. No.: US 2025/0116518 A1
(43) Pub. Date: Apr. 10, 2025

(54) ROTATIONAL RATE SENSOR HAVING A SUBSTRATE AND A SENSOR ELEMENT AND METHOD FOR PRODUCING A ROTATIONAL RATE SENSOR HAVING A SUBSTRATE AND A SENSOR ELEMENT

(71) Applicant: Robert Bosch GmbH, Stuttgart (DE)

(72) Inventors: Odd-Axel Pruetz, Nuertingen (DE); Martin Putnik, Rottenburg Am Neckar (DE); Robert Ramsperger, Empfingen (DE)

(21) Appl. No.: 18/886,275

(22) Filed: Sep. 16, 2024

(30) Foreign Application Priority Data
Oct. 6, 2023 (DE) 10 2023 209 774.5

(51) Int. Cl. G01C 19/5705

(52) U.S. Cl. CPC G01C 19/5705

(57) ABSTRACT

A rotational rate sensor having a substrate and a sensor element. The substrate is a rotor structure that can be driven to perform a rotational oscillation about a drive axis perpendicular to a main extension plane with a drive deflection using a drive device. A rotational rate can be detected using a detection device. The rotor structure includes an outer sensor frame serving as a seismic mass and a spring structure, and the spring structure is connected to the substrate in a central region using at least one substrate suspension. The spring structure between its attachment to the substrate suspension and its connection to the sensor frame includes beam elements, which extend substantially straight in sections. Each successive two of the beam elements are connected to one another at at least five points in such a way that the two beam elements form at least one 90° angle.

### CROSS REFERENCE

The present application claims the benefit under 35 U.S.C. § 119 of German Patent Application No. DE 10 2023 209 774.5 filed on Oct. 6, 2023, which is expressly incorporated herein by reference in its entirety.

### FIELD

The present invention is based on a rotational rate sensor having a substrate and a sensor element.

### BACKGROUND INFORMATION

Rotational rate sensors that detect rotational rate signals in at least one sensitive direction due to the Coriolis effect are generally available in many different versions and designs. Furthermore, certain rotational rate sensors are generally available, with which a sensor element performs a rotational oscillation about an axis of rotation, so that rotational rates can be detected in at least one sensitive direction by means of the sensor element designed as a rotor structure. The mode of operation of such rotational rate sensors provides that the sensor element or the rotor structure performs such a rotational oscillation about an axis of rotation perpendicular to a substrate (i.e., a rotational oscillation about a drive axis perpendicular to the main extension plane of the substrate) and a tilting about a tilting axis (due to the effect of the Coriolis force) occurs if a rotational rate is applied in one of the sensitive directions; such a tilting of the rotor structure can be detected via electrical detection methods, for example a capacitive differential detection and/or piezo-electrical methods, and evaluated in connection with electrical evaluation devices (ASIC).

However, conventional rotational rate sensors of this type have disadvantages with regard to fracture stability, the avoidance of non-linearities in the restoring force over the drive deflection along with the influence of manufacturing tolerances.

### SUMMARY

It is an object of the present invention to provide a rotational rate sensor having a substrate and a sensor element that, due to a design of the rotor structure or the spring structure, either does not have the above-mentioned disadvantages or at least exhibits improved behavior.

The rotational rate sensor according to the present invention having a substrate and a sensor element according to certain features of the present invention may have the advantage over the related art that, due to the structuring of the spring structure (beam elements that are substantially straight in sections and that are attached together or connected to one another in such a way that the relevant beam elements in each case form a 90° angle), it is extremely advantageous to avoid non-linearities of the restoring force with respect to deflections of the sensor element, in particular drive deflections, by (based on their arrangement) the sectionally straight beam elements being subjected as far as possible to bending and/or torsion instead of to stretching and/or compression. Possible interference modes in the detection of the rotational rate are thus advantageously shifted into the high-frequency range and efficient detection of the rotational rate in at least one sensitive direction is enabled.

Furthermore, according to an example embodiment of the present invention, a high level of mechanical fracture stability is ensured by means of the spring structure and the outer sensor frame, which serves as a seismic mass, since the stress that occurs is minimized or remains below critical stress values in the event of both a rotational drive deflection and a translational deflection, in particular due to an overload deflection or a mechanical shock (overload due to linear and/or rotational acceleration).

In addition, the structuring of the sensor frame and the spring structure during production enables extremely efficient minimization of manufacturing tolerances, since an advantageous etching environment can be used or is ensured due to the structuring, in particular the structuring of the spring structure, due to the beam elements extending straight in sections or due to stop and guide structures. In particular, this results in an advantage in relation to the manufacturing tolerances or the manufacturing errors of the dimensions and the associated spring stiffnesses of the beam elements, which extend straight in sections.

Advantageous example embodiments and developments of the present invention are disclosed herein.

According to an advantageous example embodiment of the present invention, it is provided that the rotational rate sensor comprise at least one stop and guide structure within the sensor frame, wherein the stop and guide structure is provided for realizing largely homogeneous etching environments within the sensor frame. Due to the at least one stop and guide structure, it is advantageously possible—in particular by means of stops or stop elements—to increase the mechanical fracture stability, in particular with regard to the stresses occurring in the event of a mechanical shock (overload due to linear and/or rotational accelerations) or to keep the stresses acting on the spring structure below critical values despite such a situation. In addition, the stop and guide structure advantageously provides a homogeneous etching environment or uniform etching environment within the sensor frame. In particular, this also provides such etching conditions around the spring structure and thus enables less variation in the stiffness and the widths or dimensions of the beam elements, which are substantially straight in sections, in particular in view of the existing manufacturing tolerances.

According to an advantageous example embodiment of the present invention, it is provided that the beam elements of the spring structure, which extend straight in sections, are arranged in such a way that the spring structure forms or comprises a meandering pattern and/or the spring structure comprises a frame element or a plurality of frame elements and/or the spring structure comprises torsion elements, in particular torsion springs. Due to these arrangements in particular, stretching and/or compression of the spring structure or the beam elements, which extend straight in sections, can be effectively avoided, so that these are primarily subjected to bending and/or torsion. Thus, nonlinearities with respect to the restoring force upon deflections of the sensor element can be minimized extremely efficiently, and overload deflections can be effectively counteracted.

According to an advantageous example embodiment of the present invention, it is provided that the stop and guide structure comprise stop elements. By means of the stop elements in particular, it can be ensured that a certain maximum possible deflection is not exceeded, so that stresses triggered by a mechanical shock (cases of overload, for example due to linear and rotational acceleration) can be effectively limited or kept below a critical stress value.

According to an advantageous example embodiment of the present invention, it is provided that the spring structure comprise a recess, in particular in a central region. By means of such a recess, limitations resulting from layout or underetching rules (upon production) can be effectively circumvented, so that better manufacturing tolerances can be achieved in particular.

According to an advantageous example embodiment of the present invention, it is provided that the substrate suspension of the spring structure is realized with at least one anchor, in particular with at least two anchors, preferably with at least four anchors. The substrate suspension of the spring structure is thus advantageously anchored to the substrate and complements both the spring structure and the rotor structure extremely advantageously.

A further object of the present invention is a method for producing a rotational rate sensor having a substrate and a sensor element according to features of the present invention.

The method according to an example embodiment of the present invention for producing a rotational rate sensor having a substrate and a sensor element proves to be advantageous compared to the related art in that an advantageous etching environment due to the (desired) structuring of the sensor frame and the spring structure enables an extremely advantageous minimization of manufacturing fluctuations or manufacturing tolerances. In particular, the arrangement of the (desired) beam elements extending straight in sections favors an advantageous etching environment and thus enables a high degree of containment of manufacturing fluctuations, in particular in relation to the dimensions of the beam elements and their spring stiffness. Furthermore, the spring structure is substantially only subjected to bending and/or torsion instead of stretching and/or compression due to the arrangement of the beam elements, which extend straight in sections. Thus, possible interference modes can be suppressed or shifted into the high-frequency range in an extremely advantageous manner, in particular within the detection of the rotational rate that is present in at least one direction, and effective and efficient detection of the rotational rate can be ensured. Furthermore, non-linearities in relation to the restoring force can be avoided or suppressed upon deflections, in particular with respect to the drive deflection of the sensor element. This avoidance of overload deflections ensures high mechanical fracture stability with respect to the maximum stress occurring at full deflection or tilting (i.e., to the extent permitted by the structuring), in particular during a mechanical shock.

According to an advantageous example embodiment of the present invention, it is provided that the rotational rate sensor is designed in such a way that the sensor element comprises at least one stop and guide structure within the sensor frame, wherein the stop and guide structure is designed in such a way that largely homogeneous etching environments are realized within the sensor frame during production, in particular of the spring structure of the rotational rate sensor.

The advantages and designs that have been described in connection with the example embodiments of the rotational rate sensor having a substrate and a sensor element according to the present invention can be used for the method for producing a rotational rate sensor having a substrate and a sensor element.

Exemplary embodiments of the present invention are illustrated in the figures and explained in more detail in the following description.

### BRIEF DESCRIPTION OF THE DRAWINGS

FIG. 1 shows a schematic representation of a part of a rotational rate sensor according to an example embodiment of the present invention, specifically a sensor element along with an (associated) stop and guide structure according to the embodiment shown, wherein the sensor element designed as a rotor structure comprises an outer sensor frame as a seismic mass, a substrate suspension and a spring structure located therebetween.

FIG. 2 shows a schematic and enlarged section of the sensor element shown in FIG. 1, specifically the spring structure in particular.

FIGS. 3A-3C in each case shows a schematic representation of further exemplary embodiments for realizing the sensor element of a rotational rate sensor according to the present invention.

FIG. 4 shows a schematic representation of a part of the rotational rate sensor according to a further example embodiment of the present invention, specifically again the sensor element as well as the (associated) stop and guide structure according to the embodiment shown, wherein the sensor element, which is again designed as a rotor structure, again comprises the outer sensor frame as the seismic mass, the substrate suspension and the spring structure located therebetween.

FIG. 5 shows a schematic representation of a part of the rotational rate sensor according to a further example embodiment of the present invention, specifically again the sensor element as well as the (associated) stop and guide structure according to the embodiment shown, wherein the sensor element, which is again designed as a rotor structure, again comprises the outer sensor frame as the seismic mass, the substrate suspension and the spring structure located therebetween.

### DETAILED DESCRIPTION OF EXAMPLE EMBODIMENTS

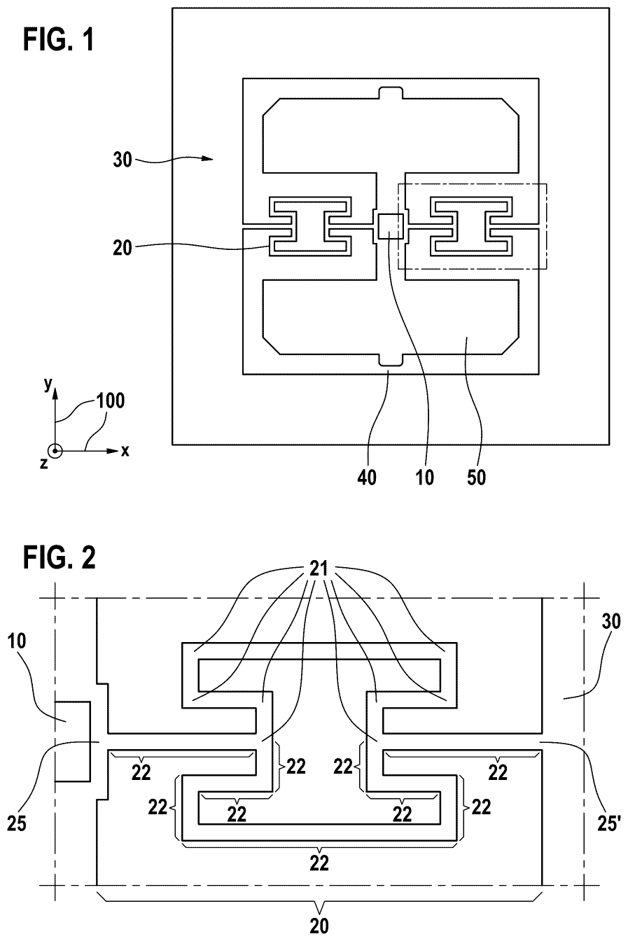

FIG. 1 shows a schematic representation of a part of a rotational rate sensor, specifically the sensor element designed as a rotor structure with an outer sensor frame 30 as a seismic mass, a substrate suspension 10 and a spring structure 20 located therebetween, according to one embodiment of the present invention. The substrate (not explicitly shown here) extends over a main extension plane 100, which corresponds to the plane spanned by the x and y axes (along with the drawing plane). The rotor structure is attached to the substrate by means of the substrate suspension 10 (by means of an anchor).

In addition to the rotor structure, FIG. 1 also shows an (associated) guide and stop structure 50, 40, which is arranged within the sensor frame (30)—but at a distance from it—and does not perform the rotational vibration together with it, but on the contrary is substantially fixed to the substrate.

The stop and guide structure 40, 50 is provided or arranged within the outer sensor frame 30, in particular at a distance both from the outer sensor frame 30 and from the partial regions of the spring structure 20, in such a way that substantially the same or similar distances arise, so that in particular the etching conditions upon the production or structuring of the rotor structure are largely uniform.

The following applies to all embodiments: The sensor element or the rotor structure—in particular the sensor frame 30—is driven by means of a drive device (not shown in any of the figures) to perform a rotational oscillation (in plane) about a drive axis (parallel to the z-axis) and, in the course of this rotation, is deflected by a drive deflection (in plane) in the sense of this rotational oscillation. By means of a detection device (also not shown in any of the figures), at least one rotational rate (or rotational rate component) applied in a sensitive direction (x-axis or y-axis) can be detected by tilting the sensor element or the rotor structure (out-of-plane) about a tilting axis (parallel to the main extension plane 100). Preferably, detection is performed by means of capacitive differential detection or readout and/or piezo-electric methods. The tilting axis (y-axis or x-axis) is aligned both perpendicular to the at least one rotational rate applied in the sensitive direction (x-axis or y-axis) and perpendicular to the drive axis (z-axis). By means of the stop and guide structure 40, 50, overload deflections with respect to the drive deflection of the sensor element can be substantially avoided in an extremely advantageous manner, so that the described advantages of high mechanical stability or fracture stability and with respect to mechanical shocks or overload can be realized. Furthermore, the stop and guide structure 50, 40, in particular in relation to the production of the rotational rate sensor, enables the realization of a largely homogeneous etching environment, as a result of which manufacturing fluctuations can be minimized, among other things, in particular with respect to etching or etching steps to be carried out upon the production of the rotational rate sensor within the outer sensor frame 30, i.e. in particular with respect to the substrate suspension 10 and the spring structure 20.

In FIG. 1 and according to all embodiments according to the present invention, the rotor structure comprises the outer sensor frame 30 serving as the seismic mass and the spring structure 20; the spring structure 20 is connected to the substrate (not shown in any of the figures) in a central region by means of the at least one substrate suspension 10, wherein the spring structure 20 is designed between, on the one hand, its one end—specifically its attachment 25 to the substrate suspension 10—and, on the other hand, its other end—specifically its attachment 25′ to the sensor frame 30—in such a way that it comprises (or consists of) beam elements 22 that extend substantially straight in sections and that in each case two successive ones of these beam elements 22 are attached together or connected to one another at at least five points 21 in such a way that the in each case relevant two beam elements 22 form at least one right angle (i.e., an angle that has or comprises at least 90°). This is also shown in detail (and enlarged) in FIG. 2 according to a section marked with a dashed line in FIG. 1:

In the left part of FIG. 2, a piece of the substrate suspension 10 is still shown, to which the spring structure 20 is attached by means of its attachment 25; in the right part of FIG. 2, a piece of the outer sensor frame 30 is shown. FIG. 2 shows only a single spring structure 20 or a partial spring structure 20 (of a total of two spring structures or partial spring structures shown in FIG. 1 and present by way of example in this exemplary embodiment).

The spring structure 20 (or partial spring structure 20) designed according to the embodiment according to FIG. 1 comprises, starting from its attachment 25 (to the substrate suspension 10), a total of nine beam elements 22 extending straight in sections, wherein with the embodiment shown, in particular the second to eighth beam element 22 form a folded-in frame structure with further analogous beam elements arranged in mirror image. The frame structure 20 (or the partial frame structure 20) comprises, at the points designated by the reference sign 21 (in the upper part of the folded-in frame structure shown in FIG. 2), in each case an angled course (with right angles in each case in the exemplary embodiment according to FIGS. 1 and 2) in the sense that two successive (and, in each case viewed separately, straight) beam elements 22 are attached together or connected to one another at these points designated by the reference sign 21 (or are structured accordingly) and in each case form the 90° angle referred to. In this respect, the spring structure 20 according to FIGS. 1 and 2 forms a meandering pattern (or comprises such a meandering pattern), wherein the nine beam elements 22 (in each case of a path between the attachments 25, 25′) comprise the 90° angle at eight points 21 located between them. Furthermore, the spring structure 20 according to FIGS. 1 and 2 also comprises a frame structure or frame element with the folded-in frame structure (comprising both the upper and the lower second to eighth straight beam element 22).

This is extremely advantageous in that the beam elements 22 (and thus also the spring structure 20) are substantially only subjected to bending and/or torsion and thus, on the one hand, stretching and/or compression of the spring structure 20 or parts thereof are avoided, so that possible interference modes can be shifted to the higher-frequency range upon the detection of the rotational rate to be measured and, furthermore, non-linearities of the restoring force, in particular with respect to the drive deflection, are minimized as far as possible.

**Thus, the spring structure 20 according to the embodiment according to FIG. 1 (or FIG. 2) is a composite of a plurality of individual segments (beam (elements) 22) and is equally responsible for the realization of the useful modes (drive and detection). Due to the meandering pattern of the spring structure 20, stretching (of the beam elements) is avoided upon deflection in the effective modes or the overall movement is enabled as far as possible by bending of the individual segments. In the event of an overload in the y-direction—e.g., with linear acceleration—the stop element (of the stop and guide structure 50, 40) marked with an arrow and the reference sign 40 can stop the overload deflection after a short distance and thus prevent damage. This topology is in particular advantageous with respect to overload with linear acceleration in the y-direction. The guide structure 50 or the stop and guide structure 50, 40 ensures a homogeneous etching environment and is in particular advantageous for minimizing manufacturing fluctuations.

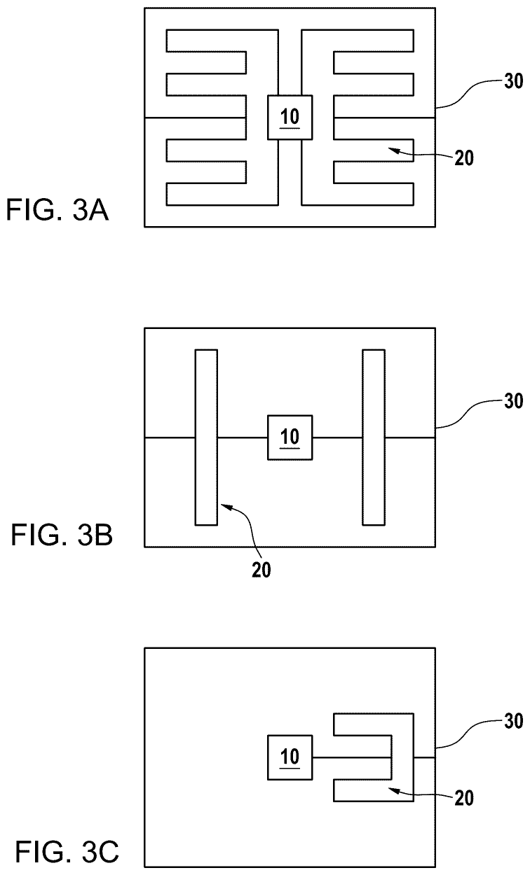

FIGS. 3A to 3C show a schematic representation of further exemplary embodiments or embodiments of alternative spring structures 20 according to the present invention, which are likewise arranged in each case (i.e., according to all of the embodiments or variants according to FIGS. 3A to 3C) between an outer sensor frame 30 as a seismic mass and a substrate suspension 10. In all embodiments (FIGS. 3A to 3C), the substrate suspension 10, the spring structure 20, which in all these embodiments comprises at least one meandering pattern 12, along with the outer sensor frame 30, are also indicated. Furthermore, the spring structure 20 with its meandering pattern consists of a plurality of successive beam elements 22 that are substantially straight in sections and that are attached together or connected to one another at at least five points in such a way that the two in each case relevant beam elements 22 form at least a 90° angle.

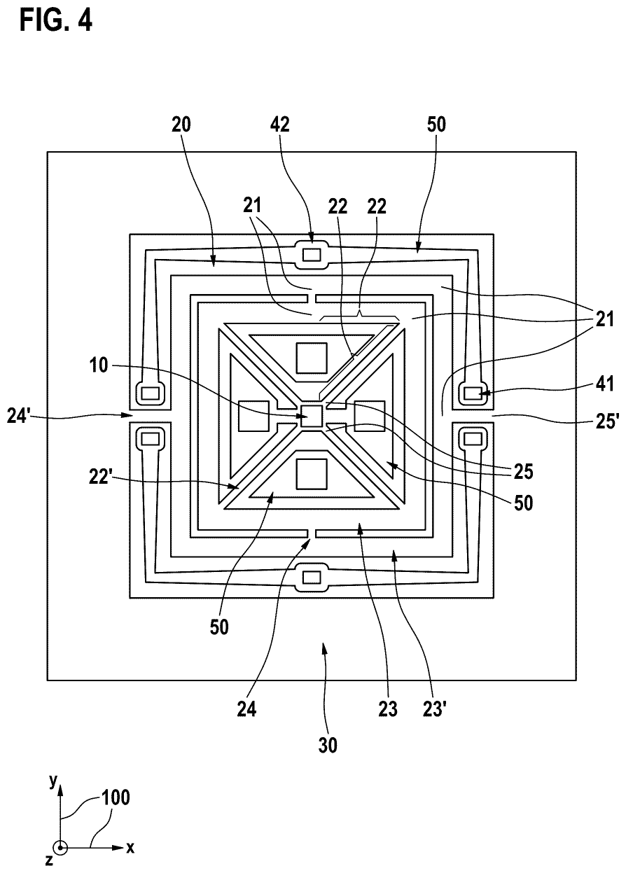

FIG. 4 shows a schematic representation of a part of the rotational rate sensor having a substrate and a sensor element according to a further embodiment of the present invention, specifically again the sensor element as well as the (associated) stop and guide structure 40, 50 according to the embodiment shown, wherein the sensor element, which is again designed as a rotor structure, again comprises the outer sensor frame 30 as a seismic mass, the substrate suspension 10 and the spring structure 20 located therebetween.

As with the embodiments described above, the stop and guide structure 40, 50 is provided or arranged within the outer sensor frame 30, in particular at a distance both from the outer sensor frame 30 and from the partial regions of the spring structure 20, in such a way that substantially the same or similar distances arise, so that in particular the etching conditions upon the production or structuring of the rotor structure are largely uniform.

With the embodiment according to FIG. 4 as well, the spring structure 20 is designed between, on the one hand, its one end—specifically its attachment 25 to the substrate suspension 10—and, on the other hand, its other end—specifically its attachment 25′ to the sensor frame 30—in such a way that it comprises (or consists of) beam elements 22 that extend substantially straight in sections and that in each case two successive ones of these beam elements 22 are attached together or connected to one another at at least five points 21 in such a way that the in each case relevant two beam elements 22 form at least one right angle (i.e., an angle that has or comprises at least 90°). In detail, the spring structure 20 according to the embodiment according to FIG. 4 comprises four individual attachments 25 to the substrate suspension 10. Starting from each of these attachments 25 to the substrate suspension 10, the spring structure 20 (up to its attachment 25′ to the sensor frame 30) comprises a total of six beam elements 22 extending straight in sections. In turn, the frame structure 20 comprises an angled course at the points designated by the reference sign 21, in the sense that two successive (and, in each case viewed separately, straight) beam elements 22 are attached together or connected to one another at these points designated by the reference sign 21 (or are structured accordingly) and in each case form the (at least 90°) angle referred to. In this respect, the spring structure 20 according to FIG. 4 also forms a meandering pattern (or comprises such a meandering pattern), wherein the six beam elements 22 (in each case of a path between the attachments 25, 25′) comprise the (at least) 90° angle at five points 21 located between them. According to the embodiment according to FIG. 4, in each case the second such beam element 22 forms an (inner) frame element 23; in each case the third such beam element 22 forms an (inner) torsion element 24; in each case the fourth beam element 22 forms an (outer) further frame element 23′; and in each case the fifth beam element 22 forms an (outer) further torsion element 24′.

Thus, for the embodiment of the spring structure 20 according to FIG. 4, the drive deflection is primarily enabled by in-plane deflection of the diagonally extending spring beams (i.e., corresponding to the (four existing) first beam elements 22, each starting from the relevant attachment 25 to the substrate suspension 10 and designated in FIG. 4 by the reference sign 22′). With the detection mode around the x-axis, the torsion spring (additional torsion element 24′) is primarily deflected; in the detection mode around the y-axis, the torsion spring (torsion element 24) is primarily deflected. This division (or “division of tasks”) between the individual elements of the spring structure 20 makes it possible, in an advantageous way, to be able to determine the frequencies of the individual useful modes using independent geometric variables. The use of the frame elements 23, 23′ and the relatively short torsion elements 24, 24′ enable parallel out-of-plane interference modes to be located at very high frequencies. The elements 50 of the stop and guide structure 40, 50 enable a homogeneous etching environment and thus a corresponding robustness against manufacturing fluctuations, while the stop elements 41, 42 help to prevent damage in the event of overload.

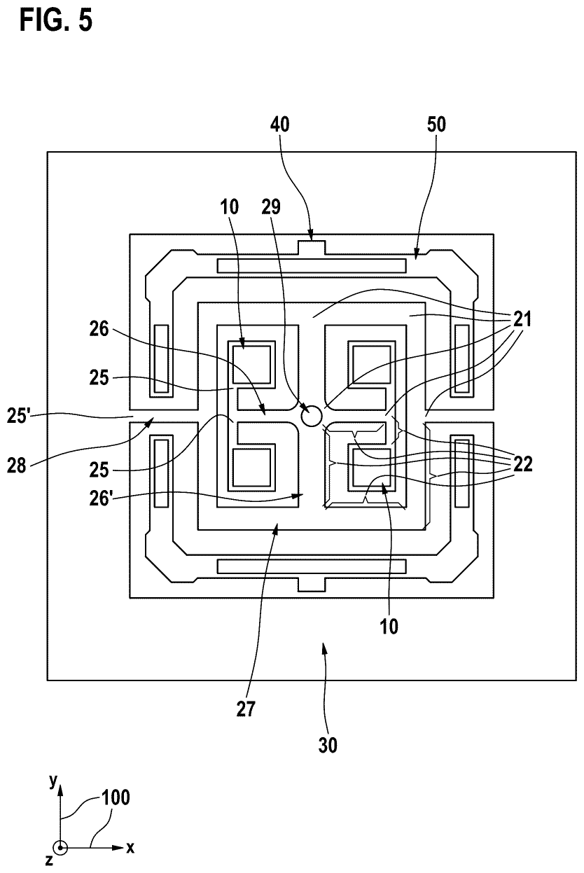

FIG. 5 shows a schematic representation of a part of the rotational rate sensor according to a further embodiment of the present invention, specifically again the sensor element as well as the (associated) stop and guide structure 40, 50 according to the embodiment shown, wherein the sensor element, which is again designed as a rotor structure, again comprises the outer sensor frame 30 as the seismic mass, the substrate suspension 10 and the spring structure 20 located therebetween.

In contrast to the above-described embodiments, the rotor structure or the spring structure 20 according to the embodiment shown in FIG. 5 is realized via a substrate suspension 10 with four anchors. As with the embodiments described above, the stop and guide structure 40, 50 is provided or arranged within the outer sensor frame 30, in particular at a distance both from the outer sensor frame 30 and from the partial regions of the spring structure 20, in such a way that substantially the same or similar distances arise, so that in particular the etching conditions upon the production or structuring of the rotor structure are largely uniform.

With the embodiment according to FIG. 5 as well, the spring structure 20 is designed between, on the one hand, its one end—specifically its attachment 25 to the substrate suspension 10—and, on the other hand, its other end—specifically its attachment 25′ to the sensor frame 30—in such a way that it comprises (or consists of) beam elements 22 that extend substantially straight in sections and that in each case two successive ones of these beam elements 22 are attached together or connected to one another at at least five points 21 in such a way that the in each case relevant two beam elements 22 form at least one right angle (i.e., an angle that has or comprises at least 90°). In detail, the spring structure 20 according to the embodiment according to FIG. 5 comprises four individual attachments 25 to the substrate suspension 10. Starting from each of these attachments 25 to the substrate suspension 10, the spring structure 20 (up to its attachment 25′ to the sensor frame 30) comprises a total of six beam elements 22 extending straight in sections. In turn, the frame structure 20 comprises an angled course at the points designated by the reference sign 21, in the sense that two successive (and, in each case viewed separately, straight) beam elements 22 are attached together or connected to one another at these points designated by the reference sign 21 (or are structured accordingly) and in each case form the 90° angle referred to. In this respect, the spring structure 20 according to FIG. 5 also forms a meandering pattern (or comprises such a meandering pattern), wherein the six beam elements 22 (in each case of a path between the attachments 25, 25′) comprise the 90° angle at five points 21 located between them. According to the embodiment according to FIG. 5, the second such beam element 22 forms a torsion element 26; in each case the third such beam element 22 forms a first further torsion element 26′; in each case the sixth beam element 22 forms an (outer) second further torsion element 28; in each case the fourth and fifth beam elements 22 form a frame element 27.

Thus, for the embodiment of the spring structure 20 according to FIG. 5, the drive movement is primarily enabled by deflection of the further torsion element 26′ (or spring) and the frame element 27; the detection movement about the x-axis is largely enabled by torsion of the torsion elements 26, 28 and the detection movement about the y-axis by torsion of the torsion element 26′. The stop and guide structures 40, 50 ensure a homogeneous etching environment, while the stop elements 40 help to prevent damage in the event of combinations of overload accelerations in the x and y directions. The recess 29 enables advantageous properties with respect to fracture robustness; it also enables an increase in the parameter space of the spring widths of the torsion elements 26, 26′, since without the recess 29 there would be a limitation due to layout rules because of underetching widths.

What is claimed is:

1. A rotational rate sensor, comprising:
a substrate having a main extension plane;
a sensor element which is configured as a rotor structure that can be driven to perform a rotational oscillation about a drive axis perpendicular to the main extension plane with a drive deflection by a drive device, wherein a rotational rate about at least one sensitive direction perpendicular to the drive axis can be detected by a detection device due to a tilting of the sensor element about a tilting axis perpendicular to the drive axis and perpendicular to the at least one sensitive direction;
wherein the rotor structure includes an outer sensor frame serving as a seismic mass, and a spring structure, the spring structure being connected to the substrate in a central region by at least one substrate suspension, wherein the spring structure, between its attachment to the substrate suspension and its attachment to the sensor frame, includes beam elements, which extend substantially straight in sections, wherein each respective two successive beam elements of the beam elements are connected to one another at at least five points in such a way that the respective two beam elements form at least a 90° angle.

2. The rotational rate sensor according to claim 1, wherein the rotational rate sensor includes at least one stop and guide structure within the sensor frame, wherein the stop and guide structure are provided for realizing largely homogeneous etching environments within the sensor frame.

3. The rotational rate sensor according to claim 1, wherein the beam elements of the spring structure, which extend straight in sections, are arranged in such a way that:
the spring structure forms a meandering pattern, and/or
the spring structure includes one or more frame elements, and/or
the spring structure includes torsion springs.

4. The rotational rate sensor according to claim 2, wherein the stop and guide structure includes stop elements.

5. The rotational rate sensor according to claim 1, wherein the spring structure has a recess in a central region.

6. The rotational rate sensor according to claim 1, wherein the substrate suspension of the spring structure is includes at least one anchor.

7. A method for producing a rotational rate sensor, the method comprising providing a substrate and a sensor element, wherein the substrate has a main extension plane, wherein the sensor element is a rotor structure that can be driven to perform a rotational oscillation about a drive axis perpendicular to the main extension plane with a drive deflection by a drive device, wherein a rotational rate about at least one sensitive direction perpendicular to the drive axis can be detected using a detection device due to a tilting of the sensor element about a tilting axis perpendicular to the drive axis and perpendicular to the at least one sensitive direction, the rotor structure including an outer sensor frame serving as a seismic mass, and a spring structure, the spring structure being connected to the substrate in a central region by at least one substrate suspension, wherein the spring structure is designed to prove the rotational rate sensor in such a way that between an attachment of the spring structure to the substrate suspension and an attachement of the spring structure to the sensor frame, the spring structure includes beam elements which extend substantially straight in sections, wherein wherein each respective two successive beam elements of the beam elements are connected to one another at at least five points in such a way that the respective two beam elements form at least a 90° angle.

8. The method according to claim 7, wherein the rotational rate sensor includes at least one stop and guide structure within the sensor frame, wherein the stop and guide structure is configured in such a way that largely homogeneous etching environments are realized within the sensor frame during production of the spring structure of the rotational rate sensor.
